(19) United States
(12) Patent Application Publication
(10) Pub. No.: US 2010/0001505 A1
(43) Pub. Date: Jan. 7, 2010

(54) Method for evaluating environmental standards of consumer items using single value to produce a calculated printed representation

(76) Inventor: Maya Elaine Lilly, Los Angeles, CA (US)

Correspondence Address: Maya Lilly, PO Box 46457, Los Angeles, CA, 90046, US

(21) Appl. No.: 12/276,389

(22) Filed: Nov. 23, 2008

Related U.S. Application Data
(60) Provisional application No. 60/990,965, filed on Nov. 29, 2007.

(51) Int. Cl. B42D 15/00

(52) U.S. Cl. 283/67

(57) ABSTRACT

The invention provides for a methodology for analyzing overall environmental impact, especially regarding greenhouse gas emissions, of consumer item(s). Factors include those that directly and indirectly impact the local, national and global environment of the planet. One embodiment of process consists of the quantization of the impact. This is delivered to the consumer as a rating name, such as but not limited to the trademark CQ, alongside an integer on an affixable label, and placed in clear view of consumer prior to purchase. Analyzing various environmental and production factors that went into production of item produces integer. Analysis also examines impact of product itself. The consumer then has opportunity to use any rewards or rebates due to the consumer to automatically mitigate the consumer's impact.

### CROSS-REFERENCE TO RELATED APPLICATIONS

This application claims the benefit of provisional patent application Ser. No. 60/990,965, filed 2007 Nov. 29 by the present inventor.

### FEDERALLY SPONSORED RESEARCH

Not Applicable.

### SEQUENCE LISTING

Not Applicable.

### BACKGROUND

1. Field of Invention

The present invention generally relates to a common methodology for evaluating consumer products on various environmental standards including but not limited to global warming, specifically using a single integer value.

2. Prior Art

Previously, the division of industrial labor has enabled many societal advantages. The main drawback to this system, however, is the inability for the average consumer to see the effect their purchases have on the environment. The cost of a product does not reflect the cost to the environment, including but not limited to climate change; decrease and/or extinction of living species, use of disease-causing chemicals, and hazardous by-products. Nor is environmental damage figured into the annual Gross-Domestic Product (GDP).

Furthermore, there is currently not one numeric value, method or process that is the same for all consumer products. The USDA's National Organic Program, passed by Congress in 1990, enforces the standard of agricultural production to organic standards and assures consumers that organically produced products meet a consistent standard. However, this labeling system is only legally applies to foodstuffs and is non-transferable to every consumer item. Wood products receive a label rating to certify a well-managed and replanted forest, the Rainforest Alliance certifies tropical conservation, and the Marine Stewardship Council's eco-label enables consumers to identify seafood that has come from a sustainable source. Cars are evaluated for emission standards and appliances for energy ratings.

However, to evaluate the average person's total “footprint”, or daily environmental impact on the planet, requires common methodology for measuring across several factors, which none of these accomplish. International Patent WO/2007/079228 (2007) to Redefining Progress provides for an automatic assessment of the environmental impact, especially regarding greenhouse gas emissions, of purchases made by consumer. The quantization of the impact is delivered to the consumer on a periodic basis. Also delivered is the opportunity to use any rewards or rebates due the consumer to mitigate the consumer's footprint. However, this does not begin at the source of consumer choice—the purchase. It is an after-effect remedy at best. The consumer must do extra work to receive the quantization, rather than knowing it on site at the moment of greatest impact: prior to purchase.

As much as the environmental analysis need be cross-sector analysis, it also needs to be in constant sight of the average consumer. A successful example of this is the Nutritional Label for foods, such as U.S. Pat. No. 5,558,742 (1996), which has affected consumer purchase due to caloric awareness. Again, this only applies to food, not all consumer products.

There are a few organizations that do approach the overall environmental analysis, such as The International Social and Environmental Accreditation and Labeling (ISEAL) Alliance and The Carbon Trust in the United Kingdom. Although the first focus is on a common methodology, it lacks a simple device easily understood by the general populace, such as what is proposed here. As to the latter, the British Standards Institution has published PAS 2050, the product carbon foot-printing standard. As of this date, this process is only in effect for UK businesses.

In conclusion, insofar as I am aware, no process or method to provide an overall environmental evaluation of consumer products exists.

### SUMMARY

Accordingly, it is an object of the present invention to provide an improved method of environmental analysis of consumer products.

It is a further object of the present invention to provide a methodology that analyzes one or more than one environmental factor.

It is yet another object of the present invention to have this method be consistent, clearly understandable, and continuously visible to consumer at time of purchase.

The method is effective, simple, thorough, and memorable.

The previous describe only one embodiment of the invention. These and other objects, features and advantages of the present invention will become apparent from the following description and accompanying drawings of one specific embodiment thereof.

### DRAWINGS

FIG. 1 is a perspective front view of one embodiment labeled with CQ™ the Consumption or Carbon Quotient (Lilly) and a positive integer rating with one decimal place.

FIG. 2 shows a perspective top view of another embodiment with CQ label and positive integer of two decimal places.

FIG. 3 is another top front view of another embodiment with CQ™ label and negative integer.

FIG. 4 is a side view of another embodiment with a CQ™ letter rating.

FIG. 5 is a flowchart for climate change factors pertaining to item.

FIG. 6 is a flowchart for conservation factors pertaining to item.

FIG. 7 is a flowchart for organic production factors pertaining to item.

FIG. 8 is a flowchart for recycling factors pertaining to item.

FIG. 9 is a flowchart for human health factors pertaining to item.

FIG. 10 is a flowchart for corporate responsibility factors re: item.

FIG. 11 is a flowchart for humane treatment factors pertaining to item.

### REFERENCE NUMERALS

| | |
|---|---|
| 102 Article | 202 Article |
| 104 Opaque Affixable Label | 204 Clear label |
| 106 CQ ™ | 206 CQ ™ |
| 108 Positive integer | 208 Positive integer |
| 302 Article | 402 Article |
| 304 CQ ™ | 404 Letter grade |
| 306 Negative Integer | 406 Hanging label |

### DETAILED DESCRIPTION

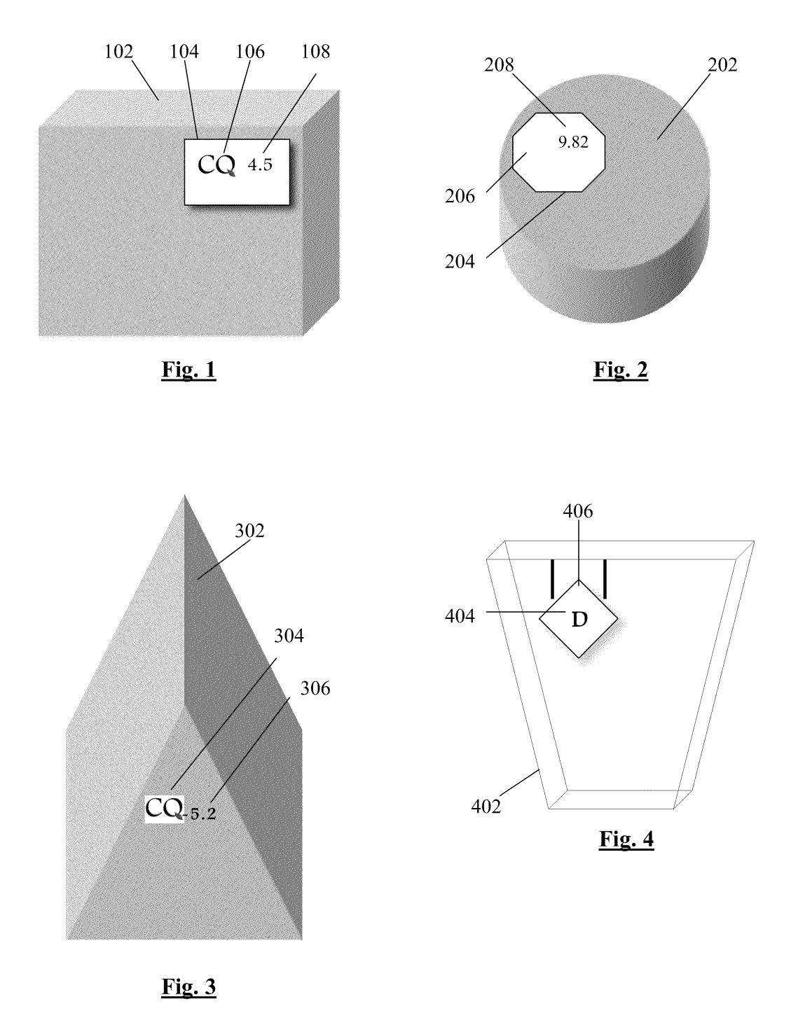

### FIGS. 1-5—Preferred Embodiment

The preferred embodiment of the method is illustrated in FIG. 1 through FIG. 4. The trademark CQ (Lilly), which stands for Consumption Quotient or Carbon Quotient, is printed on an affixable label, and opposite the trademark is an integer with two decimal points. This numeral refers to 1,000 possible analysis data of various environmental factors, with environment defined as the impact of human activity on the natural world. These include but are not limited to: Climate Change; Greenhouse Gas Emissions; Conservation of Natural Resources; Organic Materials; Byproducts; Recycling and Reuse; Human Health; Humane Treatment of Living Beings; and Corporate Responsibility. The assessment is not reserved just for negative impact factors, but positive as well. It takes into account the ramifications of all aspects of the life of the product, including but not limited to raw materials, packaging, manufacturing/production, transport, and distribution. It is giving the most accurate assessment of a product, not only acting as a watchdog agency. This embodiment gives the higher integer a greater environmental impact.

FIGS. 1-4 are all physical variations of the same calculating process, differences providing more or less scale pending consumer response to method.

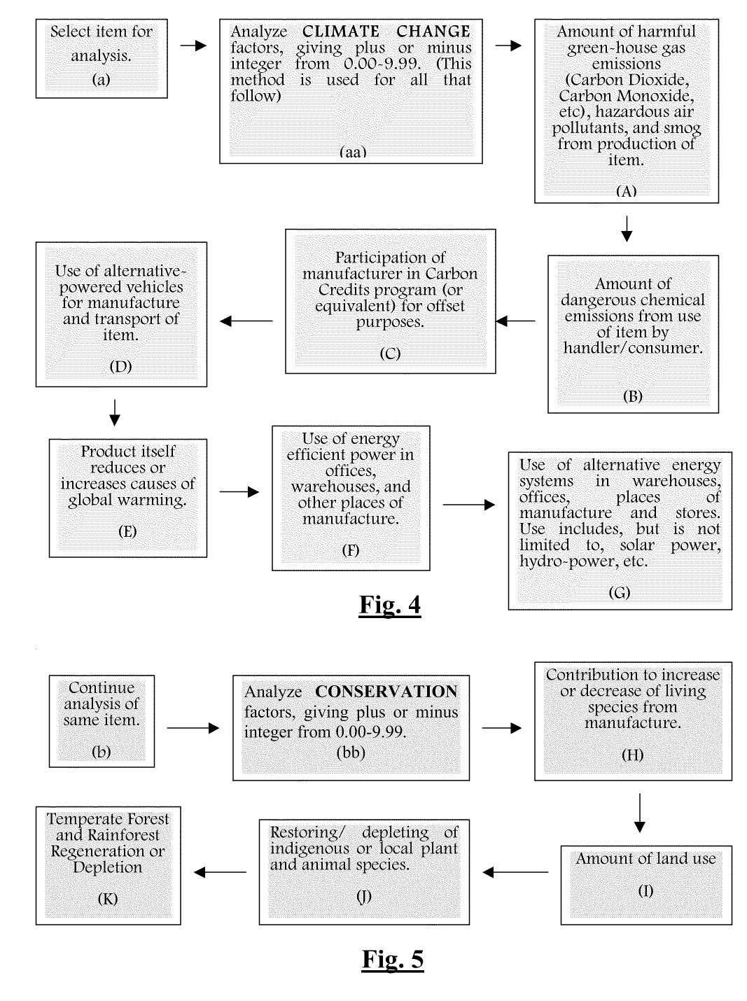

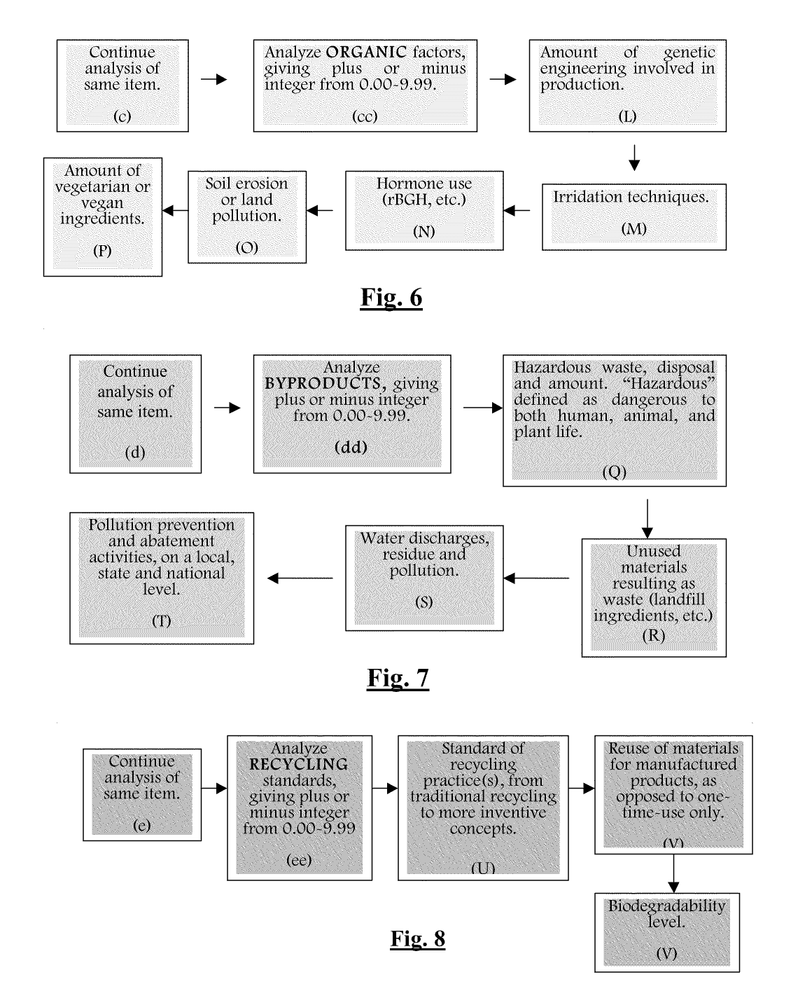

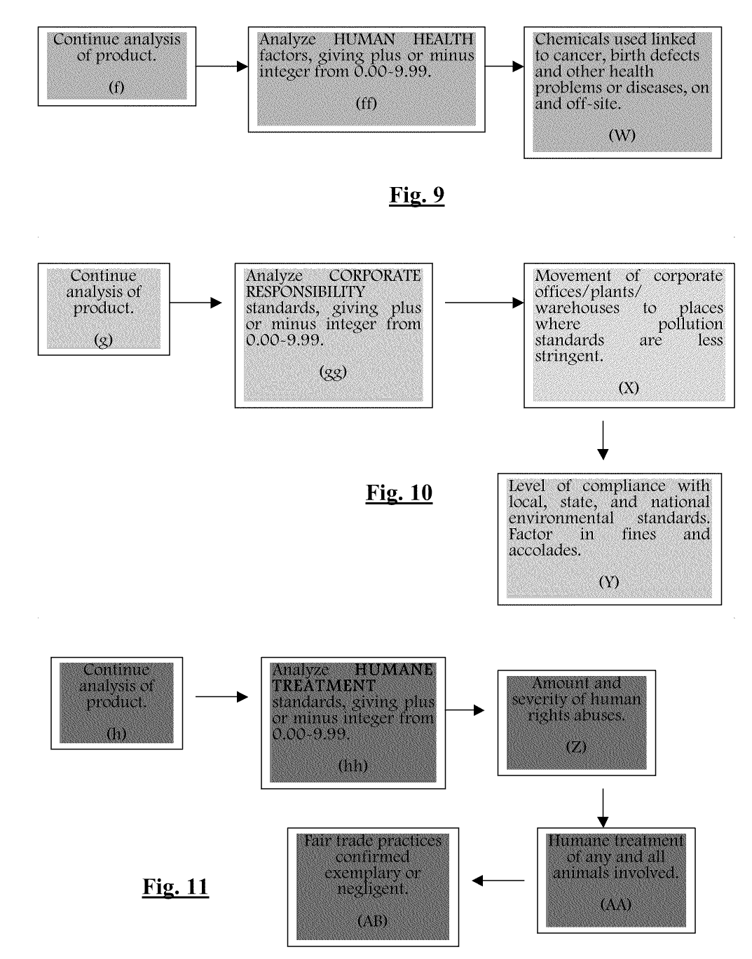

FIGS. 5-11 are flow charts of the methodology of how CQ™ (Lilly) is calculated. This will be discussed further in following paragraphs.

Although particularly suited to analyzing consumer products, this method of the present invention can also be applied to concepts, corporations, companies, restaurants and stores, eras of time, people, processes, acts of God, and other methods or processes.

Inasmuch as the present invention is subject to many variations, modifications and changes in detail, it is intended that the subject matter discussed above and shown in the accompanying drawings be interpreted as illustrative and not in a limiting sense.

### Operation

The operation of the embodiment of the method involves study standards, specifically the analysis of production and use of product(s). It also involves compliance, documentation, planning, record keeping and inspection. All these will factor into the creation of one single value for labeling.

As shown in FIGS. 1-4, a label would be applied to a consumer item in a way clearly visible to consumer. This label would contain a means of identification, such as but not limited to the trademark CQ (Consumer or Carbon Quotient), alongside a numeral.

As shown in FIGS. 5-11, these factors should be considered in analysis of item to create integer, but are in no particular order, nor need all be used. They all pertain to various interrelated aspects of the environmental situation. They must be analyzed to effectively understand the true impact of a product. Factors determining impact are subject to update and change based on most current scientific findings.

In operation one uses this method as one would use a Nutritional Label—to compare and contrast value and to ascertain consumption level. Thus, it avoids the post-decision environmental impact that prior-art methods experience.

### Description and Operation of Alternative Embodiments

The structure of the preferred embodiment is as a label with the method of analysis, specifically but not limited to CQ™, clearly shown on product.

Another embodiment is as a credit card accruing advantage, loyalty or reward points from use. Consumers would accrue their own weekly, monthly, or yearly rating or CQ™, which would enable benefits and/or penalties.

Another embodiment is as a Daily Recommended Value, such as what currently exists for Calorie labels on food items. This is a method of comparison for the average consumer to a suggested amount relating but not limited to his carbon “footprint”.

Another embodiment is an imitation of the Carbon Credit/Greenhouse Gas Debit system. One way for governments to fund or encourage reduction of carbon emissions is the credit/debit system. Under this system, an industry can effectively pay for a license to emit greenhouse gases such as CO2 into the atmosphere by purchasing a license/credit from a carbon reducing company/organization, or a company/organization that has been able to economically reduce their carbon emissions. Likewise, the analysis method could be used for companies to manage their overall rating or CQ™ by purchasing credit from a company with a better overall environmental analysis.

### Advantages

From the description above, a number of advantages of some embodiments of the environmental impact methodology become evident:

(a) The scope of the environmental situation is more clearly illuminated.

(b) The impact of the analysis system is used at key moment of purchase.

(c) The system provides for one rating system across multiple platforms, as opposed to many. This limits confusion of consumer.

### Conclusion, Ramifications, and Scope

As previously stated, there currently exists no analysis system that: 1. Is easily seen by consumer at time or purchase; 2) factors in all environmental issues, both of production and use; and 3) analyzes both positive and negative factors. No prior art comes close to the preferred embodiment of the invention.

While my above description contains many specificities, these should not be construed as limitations on the scope of the invention, but rather as an exemplification of one (or several) preferred embodiment thereof. Many other variations are possible. For example, the integer could be displayed by itself without a trademark. The integer analysis could manifest as an alphabet letter score from A-F, as shown in FIG. 4, if this proves more effective. Also, the affixed label could take the embodiment of a computer panel, can be directly printed on the item at time of production, and/or could be eliminated entirely if the method could still be visible to the naked eye. It could be of any color that compliments the visibility. The analysis could also be included in periodicals, magazines, newspapers, and reports in addendum. The system could mimic the carbon credit system, with incentives for lower rated individuals. Or, it could resemble a caloric label with a Daily Recommended Value.

Accordingly, the scope of the invention should be determined not by the embodiment(s) illustrated, but by the appended claims and their legal equivalents.

What is claimed is:

1. A method of providing one numeric value calculating projected environmental and greenhouse gas impacts for consumer products of all forms.
